(19) United States
(12) Patent Application Publication
(10) Pub. No.: US 2025/0345966 A1
(43) Pub. Date: Nov. 13, 2025

(54) ROTATIONAL CRAFT TOOL

(71) Applicant: Small Ceramics Ltd., Brentford (GB)

(72) Inventor: Stefano Caso, Brentford (GB)

(73) Assignee: Small Ceramics Ltd., Brentford (GB)

(21) Appl. No.: 19/204,510

(22) Filed: May 10, 2025

(30) Foreign Application Priority Data
May 10, 2024 (GB) 2406535.1

(51) Int. Cl. B28B 1/20; B28B 17/00

(52) U.S. Cl. CPC B28B 1/20; B28B 17/0063

(57) ABSTRACT

Disclosed herein is a rotational craft tool including a housing, a motor included in the housing, a turntable assembly, and a battery included in the housing to provide power to the motor to rotate the turntable assembly.

### FIELD OF THE INVENTION

The present disclosure generally relates to the field of craft tools. Specifically, the present disclosure pertains to electrically powered rotational craft tools that facilitate rotational manipulation of various materials. More specifically, the present disclosure is concerned with tools used in applications such as pottery, culinary decoration, and other crafts requiring rotational movement.

### BACKGROUND OF THE INVENTION

Rotational craft tools are used in various arts and crafts for manipulating materials through spinning or rotational motion. These tools, often incorporating turntables, are especially prevalent in fields such as pottery, where precise and controlled rotational movement of the turntable facilitates shaping and forming clay objects. Rotational craft tools are also used in culinary arts, such as cake decorating, where turntables facilitate the application of symmetrical and detailed patterns.

Some prior rotational craft tools have relied on manual operation or basic electric systems that offer limited control over the speed and direction of the turntable's rotation. The power systems in these conventional tools may be restricted in mobility and flexibility due to reliance on constant electrical connectivity.

Some prior rotational craft tools experience performance deficiencies due to inconsistent rotational speeds that vary with the torque required for different load weights and user interactions. As the weight of the material or resistance from user manipulation increases, the torque applied by the motor may not adequately compensate, leading to fluctuating speeds that can adversely affect the precision and quality of the work. This inconsistency in speed can be problematic in applications such as pottery and culinary decorating, where steady and predictable turntable motion is crucial for achieving desired artistic and functional outcomes.

Some prior rotational craft tools employ a combination of switches, pedals and knobs to set the rotational direction and the speed of the turntable within that direction. While functional, this method introduces complexity and inconvenience in operation, particularly when precision and rapid adjustments are necessary. Users are often required to manually toggle between different settings to achieve the desired operation, which can interrupt the flow of work and reduce efficiency. Such a setup is especially cumbersome in tasks requiring frequent changes in speed and direction, as is common in detailed craftwork and artistic applications.

Thus, there is a need for improved rotational craft tools that offer enhanced control, precision, and usability.

### BRIEF SUMMARY OF THE INVENTION

The above mentioned and other features and advantages of the disclosure will be best understood from the following description referring to the attached drawings. In the drawings, like reference numerals denote identical parts or parts performing an identical or comparable function or operation.

In a first aspect, a rotational craft tool is provided comprising a housing, a motor included in the housing, a turntable assembly, the motor operatively connected to the turntable assembly for rotating the turntable assembly, a battery included in the housing to provide power to the motor.

In a second aspect, a rotational craft tool is provided including a housing, a motor included in the housing, a turntable assembly, the motor operatively connected to the turntable assembly for rotating the turntable assembly, and a control system configured to adjust a speed or power of the motor using a feedback loop in which an error between a setpoint rotational speed of the motor and a sensed rotational speed of the motor is minimized.

In a third aspect, a rotational craft tool includes a housing, a motor included in the housing, a turntable assembly, the motor operatively connected to the turntable assembly for rotating the turntable assembly, and a dial operable by a user, wherein a rotational direction of the dial sets a rotational direction of the turntable assembly by the motor and an extent of rotation sets a speed of rotation of the turntable assembly by the motor in the rotational direction.

In a fourth aspect, a rotational craft tool is provide including a turntable assembly, a motor for rotating the turntable assembly, a battery for supply power to the motor, and a housing containing the motor and the battery, wherein the housing comprises a housing base and a housing main body, wherein the housing base comprises a damping layer and a support frame, the damping layer surrounding a periphery of the support frame such that when the housing is placed on a horizontal surface, the damping layer contacts the horizontal surface and the support frame is held by the damping layer spaced from the horizontal surface.

In a fifth aspect, a rotational craft tool, comprises a turntable assembly, a motor for rotating the turntable assembly, and a dish assembly surrounding the turntable assembly for splash protection, wherein the dish assembly comprises a first dish half and a second dish half that are detachable from each other for removal from the rotational craft tool. The first dish half and the second dish half are magnetically securable to one another, the first dish half and the second dish half each including a magnet, and a ferromagnetic insert, wherein the magnet of the first half dish arranged to face the ferromagnetic insert of the second half dish and the magnet of the second half dish arranged to face the ferromagnetic insert of the first half dish when the first half dish and the second half dish are secured to one another.

In a sixth aspect, a rotational craft tool is provided including a housing, a turntable assembly, a battery, a motor assembly comprising a motor and a gear box housing, the gear box housing comprising a gear assembly, wherein the turntable assembly is rotatable by the motor via the gear assembly and is powered by the battery, and wherein the motor is elongate and includes a longitudinal motor axis and the battery is elongate and includes a longitudinal battery axis, the battery arranged within the housing above the motor when the rotational craft tool is placed on a horizontal surface and such that the motor axis and the battery axis are perpendicular to one another.

In a seventh aspect, a rotational craft tool is provided including a housing, a motor included in the housing, a turntable assembly, the motor operatively connected to the turntable assembly for rotating the turntable assembly, and a data transfer method to control software or hardware.

In an eight aspect, a rotational craft tool is provided including a housing, a motor included in the housing, a turntable assembly, the motor operatively connected to the turntable assembly for rotating the turntable assembly, and a battery included in the housing to provide power to the motor, and a wireless connectivity to wirelessly charge the battery or power the motor directly or both

In a ninth aspect, a rotational craft tool is provided comprising a housing, a motor included in the housing, a turntable assembly, the motor operatively connected to the turntable assembly for rotating the turntable assembly;, a battery included in the housing to provide power to the motor, a printed circuit board (PCB) for controlling at least operation of motor, and a power delivery chip compatible with USB-C Power Delivery (PD) standards, capable of dynamically controlling and adjusting voltage and current supplied to the printed circuit board (PCB) via any standard USB interface, including configurations using adapters to convert from other USB types to USB-C.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are therefore not to be considered to be limiting of its scope, the principles herein are described and explained with additional specificity and detail through the use of the accompanying drawings in which:

FIG. 1 provides a perspective view of a rotational craft tool illustrating the a housing, a turntable assembly, a dish assembly, and a dial in accordance with embodiments of the present disclosure.

FIG. 2 presents an end view of the rotational craft tool at an end opposite to an end including the dial illustrating a power button, and a USB port in accordance with embodiments of the present disclosure.

FIG. 3 displays an exploded views of the rotational craft tool in accordance with embodiments of the present disclosure;

FIG. 4 illustrates a perspective view of the a half dish of a dish assembly of the rotational craft tool in accordance with embodiments of the present disclosure;

FIG. 5 displays another exploded view of the rotational craft tool in accordance with embodiments of the present disclosure;

FIG. 6 provides a cross-sectional view of the rotational craft tool in accordance with embodiments of the present disclosure;

FIG. 7 provides a view of a turntable assembly with a turntable and a batt separated in accordance with embodiments of the present disclosure;

FIG. 9 provides a view of a housing base of a housing of the rotational craft tool showing damping features of the housing base in accordance with embodiments of the present disclosure;

FIG. 10 provides a schematic block diagram of a control system in accordance with embodiments of the present disclosure;

FIG. 11 shows a more detailed view of a gear assembly of the rotational craft tool, in accordance with embodiments of the present disclosure; and

FIGS. 12A to 12C illustrate alternative embodiments of the dish assembly in accordance with some embodiments.

FIG. 13 illustrates a simplified representation of an alterative turntable assembly 12 in accordance with embodiments of the present disclosure.

### DESCRIPTION OF ILLUSTRATIVE EMBODIMENTS

Embodiments contemplated by the present disclosure will now be described in more detail with reference to the accompanying drawings. The disclosed subject matter should not be construed as limited to only the embodiments set forth herein. Rather, the illustrated embodiments are provided by way of example to covey the scope of the subject matter to those skilled in the art.

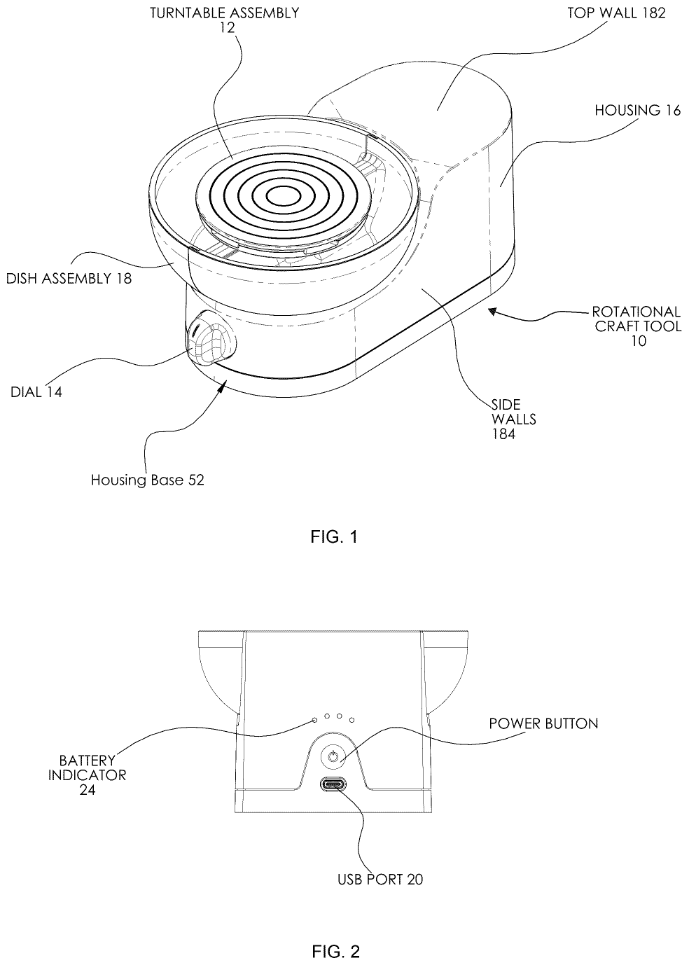

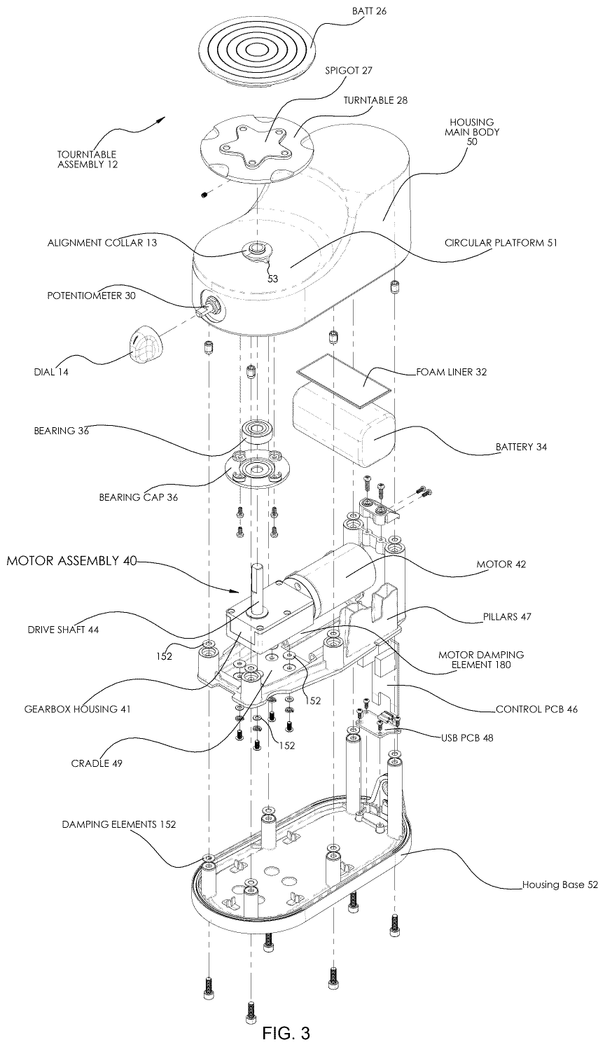

FIG. 1 shows a perspective view of a rotational craft tool 10 according to one exemplary embodiment including a turntable assembly 12, a housing 16, a dish assembly 18 surrounding the turntable assembly 12 and a dial 14. The turntable assembly 12 serves as a platform for engaging with materials or objects that are to be crafted. It is responsible for the rotational movement that allows for tasks such as moulding, sculpting, decorating, including material removal processes, material addition processes, and other finishing processes. The turntable assembly includes a flat, circular platform. The turntable assembly 12 is located at an upper part of the housing 16. The turntable assembly 12 includes a removable batt 26 (see FIG. 3, for example) that is interchangeable to accommodate different sizes or materials that are being worked on by a user (e.g. clay, culinary or other craft materials). The removable batt 26 may feature a textured surface to prevent slippage of materials being worked upon, help with the visual centre, or imprint a pattern in a malleable body.

The housing 16 encases various internal components such as a motor 42 and a battery 34 (see FIG. 3, for example), protecting them from external elements and wear while also providing structural support to the entire tool. The housing 16 is typically constructed from plastic but may be constructed from metal in some examples. The housing 16 is generally obround in shape when viewed from above. The obround shape has two opposite sides that are straight and parallel to each other and two ends of the obround shaped housing 16 are capped with a semi-circle.

The dish assembly 18 acts as a containment area surrounding the turntable assembly 12 to catch any material spillage or debris that occurs during the crafting process. The dish assembly 18 is shaped like a shallow bowl. The dish assembly 18 may be made from materials that are easy to clean and resistant to the materials being handled, such as stainless steel, silicone, or plastics. The dish assembly 18 features a removable design for easy cleaning, as described below.

The dial 14 is used to manually adjust the speed and the direction of the rotation of the turntable assembly 12, allowing the user to customize operation according to specific task requirements. The dial 14 is a rotary knob located on the housing 16, connected through mechanical and/or electronic means to a control system 80 of a motor 42 (described further below). The dial 14 serves as a primary user interface for setting desired speed and rotation direction of the turntable assembly 12. The dial 14 is positioned beneath the dish assembly 18 on the housing 16 for optimal accessibility and is located at one end of the obround shaped housing 16. The dial 14 is operable such that rotating the dial away from a central, null position sets a speed and direction of the turntable assembly. The direction of rotation of the dial 14 relative to the null position determines a direction of rotation of the turntable assembly 12. A clockwise rotation of the dial 14 from the null position sets a clockwise (or counterclockwise) direction of rotation of the turntable assembly 12, while a counterclockwise rotation of the dial from the null position reverses the direction of rotation of the turntable assembly 12. The extent of the rotation of the dial 14 from the null position correlates to a magnitude of speed adjustment of the turntable assembly 12.

The rotational craft tool 10 may be an ultra-compact craft tool. In embodiments, the turntable assembly 12 of the rotational craft tool 10 has a working surface (which supports the material to be worked such as clay for pottery) with an outer diameter typically ranging from 10 mm to 180 mm. The turntable assembly 12 may include a batt 26 (providing the working surface) and a turntable 28 as described further below. At least the batt 26 and optionally also the turntable 28 has an outer diameter falling within the range of 10 mm to 180 mm. Integrating advanced operational capabilities as described herein into such a diminutive tool presents engineering challenges that have been overcome by embodiments of the present disclosure. The small scale of the housing 16 limits the physical room for components, including the motor 42, battery, 34 and control systems.

FIG. 2 provides an end view of the rotational craft tool 10 at an end opposite to the end including the dial 14. FIG. 2 illustrates a battery indicator 24, a power button 22 and a Universal Serial Bus (USB) port 20.

The USB port 20 provides an interface for both powering the rotational craft tool 10 (specifically the motor 42) and charging the battery 34. This feature allows the rotational craft tool 10 to be used with a variety of USB power sources, including computer USB ports, USB wall chargers, and portable power banks. While a USB-C port is depicted, alternative configurations could include micro-USB or USB-A ports. Additionally, the port could be used to update the software that controls the electronics of the craft tool, enhancing functionality or performance through firmware upgrades. Moreover, leveraging the latest USB-C PD (Power Delivery) protocol, the internal battery can also be used to power other devices when connected, providing added utility and flexibility.

The power button 22 acts as a control for switching the rotational craft tool 10 on and off. The power button 22 may be a mechanically depressible button, a touch-sensitive button, a sliding switch or other known button kinds.

The battery indicator 24 provides a visual representation of a charge level of the battery 34. The battery indicator 24 is, in this example embodiment, in the form of an arrangement of LED lights above the power button 22. Other forms and locations of the battery indicator 24 may be provided including a graphic on a small LCD display.

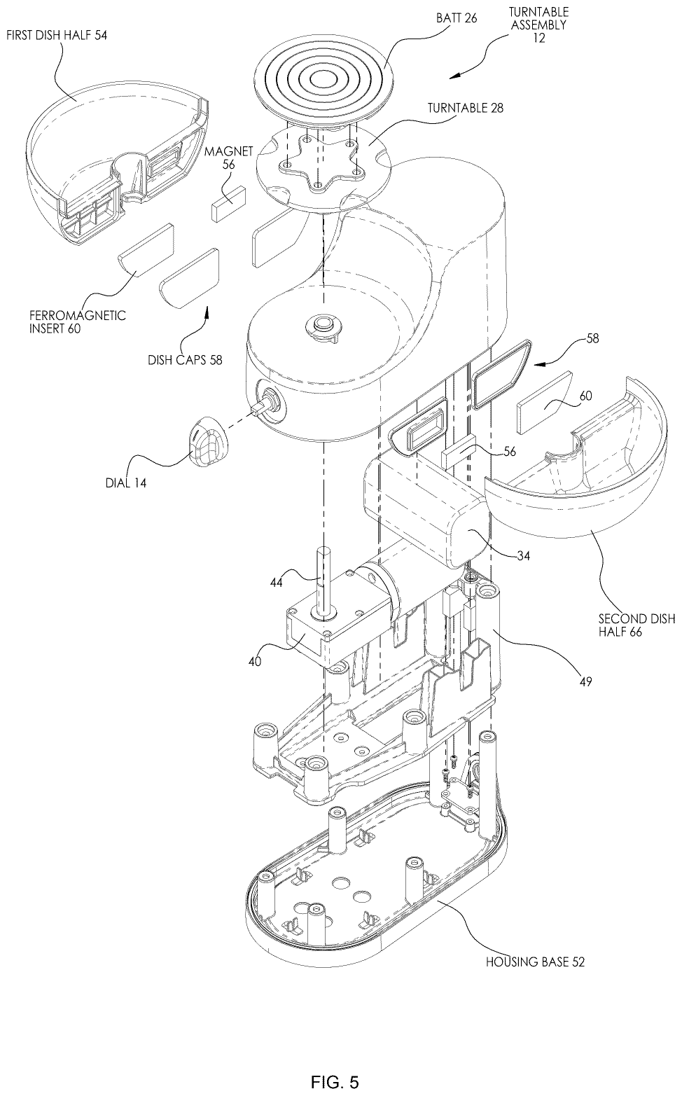

FIGS. 3 and 5 illustrate exploded views of the rotational craft tool 10 including a housing main body 50 and a housing base 52 that are connected to form the housing 16, a turntable assembly 12 including a turntable 28 including a spigot 27, a batt 26 including a socket, the dial 14, a potentiometer 30, a bearing 36, a bearing cap 38, a motor assembly 40 including a drive shaft 44 and a motor 42, a battery 34, a foam liner 32, a control PCB 46 and a USB PCB 48. Additionally, the housing is designed to offer protection to these internal components from water and dust, enhancing the durability and reliability of the tool in various environmental conditions. This protection may include seals and gaskets at critical junctures to prevent ingress and ensure the tool's continued performance even in demanding settings.

The housing main body 50 and housing base 52 together form the housing 16 and provide an outer casing of the rotational craft tool 10. The housing main body 50 and the housing base 52 connect through a variety of possible fasteners and enclose and support internal components described below.

The housing main body 50 includes a circular platform 51 above which the turntable 28 rotates. In a centre of the circular platform 51, there is an alignment collar 13 secured to an opening in a centre of the circular platform 51. The alignment collar 13 encircles and rotatably supports the drive shaft 44 passing through it. The alignment collar 13 is not a bearing per se, as it maintains a minimal clearance with the drive shaft 44, rather than direct contact. The alignment collar 13 features opposed tabs 53 designed to engage with corresponding recesses 55 in each half of the dish assembly 18, thereby ensuring precise alignment and stable assembly of the dish components.

The turntable assembly 12 includes two main components: the turntable 28 and the batt 26. The turntable 28 is a circular platform crafted from durable materials such as machined aluminium or high-strength composites. The turntable 28 includes a centrally located spigot 27 that protrudes upward to engage with a corresponding socket of the batt 26. The batt 26 includes the socket and may be manufactured from polymers, wood-based materials, or metals. The socket is tailored to snugly fit the spigot 27 of the turntable 28 ensuring that the batt 26 and the turntable 28 are rotationally fixed. In the illustrated exemplary embodiment, the spigot is star shaped having 5 points, although other numbers of points for a star may be included (such as 4 or 6). Other shaped spigots may be provided such as rectangular (including square), triangular), pentagonal, circular, etc. The batt 26 acts as the primary work surface that comes into direct contact with materials being crafted. The batt 26 and turntable 28 may be offered in multiple sizes, shapes, or with different surface textures to enhance utility across a wide range of materials and crafting applications.

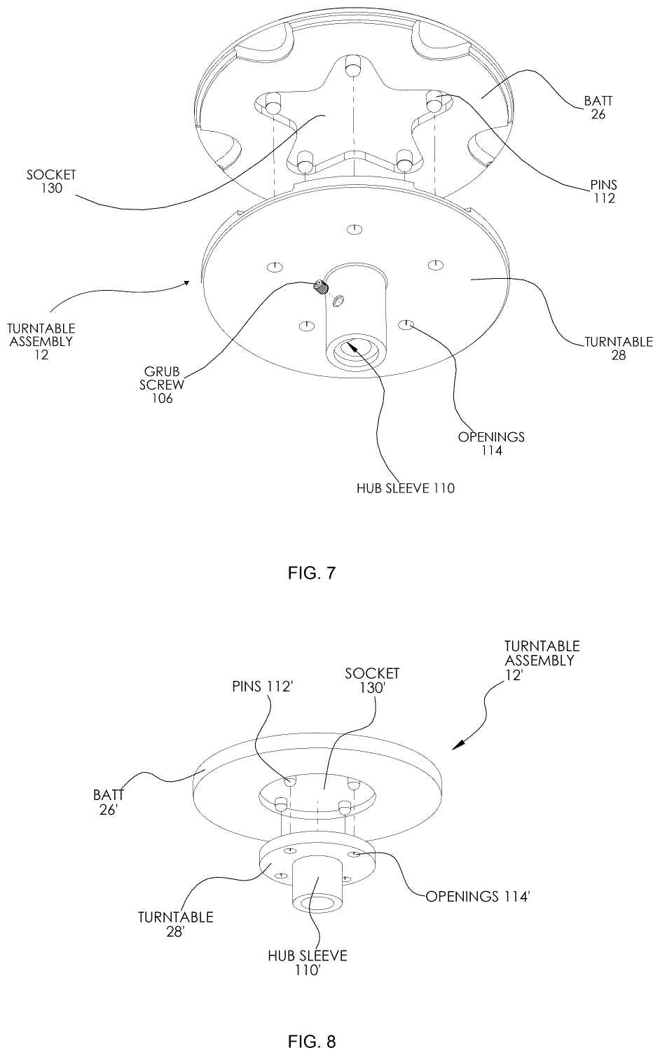

Referring briefly to FIG. 7, a view of the turntable assembly 12 is provided from an underside. The turntable assembly includes the batt 26 and the turntable 28 as described in the foregoing. The turntable 28 includes a socket 130 for receiving the spigot 27 of the turntable 28. Further illustrated is that the socket 130 encompasses depending pins 112 that are fittingly receivable in openings 114 of the turntable 28. The openings 114 are through holes in the illustrated embodiment but may be provided as blind holes in alternative embodiments. In alternative embodiments, the pins may be provided on the turntable and the openings on the batt. It has been found that having at least three pins 112 provides enhanced rotational torque transmission and also minimizes the risk of any vertical movement of the batt 26 relative to the turntable 28, which can occur during certain crafting operations. The turntable 28 includes a central integrated hub sleeve 110 that depends (extends downwardly) relative to the main circular disc of the turntable 28 that interfaces with the batt 26. The hub sleeve 110 defines a keyed passage for receiving a keyed surface 45 of a drive shaft 44 of the motor assembly 40. A grub screw 106 is provided for secure engagement with the keyed surface 45 of the drive shaft 44 for ensuring torque transmission and also preventing vertical movement of the turntable 28 relative to the drive shaft 44. The keyed passage of the hub sleeve or the grub screw 106 may not be provided in some embodiments.

In FIG. 8, a turntable assembly 12′ according to an alternative embodiment is illustrated. In the embodiment of FIG. 8, by comparison with the foregoing embodiments, the turntable 28′ has a smaller diameter than the batt 26′ and does not include a spigot. As such, it should be understood that whilst the earlier embodiments show a turntable and batt having equal and coterminous diameters, variants can be provided in which the turntable has a variety of smaller diameters relative to the batt. Further, the spigot can be provided in a variety of forms and can even be excluded. The turntable 28′ interfaces directly with the socket 130′ in the embodiment of FIG. 8, whilst rotational fixation is achieved by pins 112′ of the batt 26′ (included within the socket 130′) fittingly engaging openings 114′ of the turntable 28′.

A further alternative is envisaged (not shown) in which the turntable assembly does not include a batt and the turntable itself is mounted on the end of the drive shaft 44 and provides the work surface itself.

Referring back to FIGS. 3 and 5, the dial 14 is mechanically linked to a potentiometer 30, which translates rotational movement into variable electrical resistance, which can be detected by the control system 80 in the form of a varying voltage or current. The dial 14 allows the user to adjust speed and rotational direction settings of the turntable 28. The dial position results in a control signal that is fed into the control system 80 (see FIG. 10) via the potentiometer 30 to modulate an output of the motor 42. Alternatively, the dial could be linked to a rotary encoder that provides precise positional feedback directly to the control system 80. Both configurations might include a visual representation, such as an LED indicator or a digital screen or markings, to display the current settings.

The bearing 36 ensures smooth, consistent rotation of the of the drive shaft 44, and thus the turntable 28, with minimal friction and wear. The bearing 36 may be a ball bearing. The bearing 36 and the bearing cap 38 include a central opening that receive the drive shaft 44 therethrough. The bearing 36 is located between the bearing cap 38 and the turntable 28. The bearing cap 38 is secured to an underside of the housing main body in alignment with a central opening of the circular platform 51 and supports the bearing 36 in a fitting receptacle of the bearing cap 38. The bearing 36 because of its tight fitting with the drive shaft 44 inhibits water ingress into the housing main body 50.

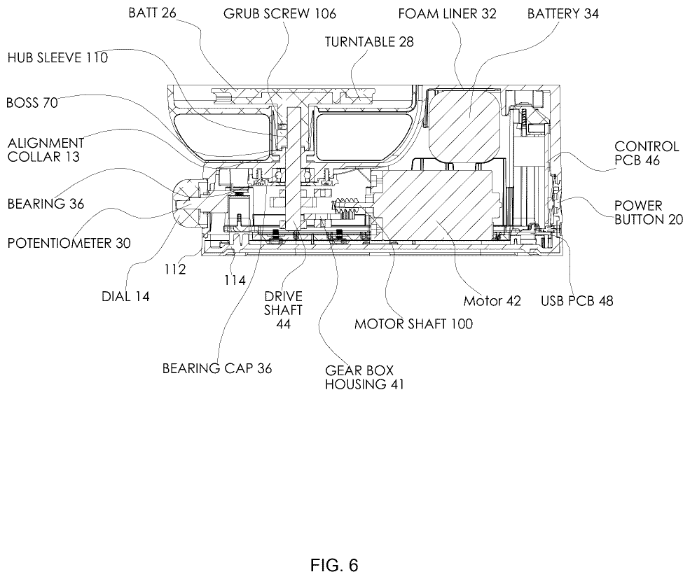

The motor assembly 40 in the rotational craft tool 10 comprises a compact cylindrical motor connected to a rectangular gearbox housing 41. The motor 42 is strategically positioned within the housing main body 50 and operates a gear assembly or transmission assembly (included within the gear box housing 41) and designed to transfer rotational motion from a motor shaft 100 (see FIG. 6) of the motor 42 to the drive shaft 44. The motor 42 is a brushless motor in one example embodiment.

The motor 42 comprises a primary motor shaft 100 (see FIG. 6) that extends into the gear box housing 41. The motor 42 generates the rotational force required to drive the turntable assembly 28. The primary motor shaft 100 engages with a gear assembly within the gearbox housing 41 to translate the rotational force of the motor 42 to the drive shaft 44 that connects to the turntable 28.

The rectangular gearbox housing 41 encases the gear or transmission assembly that adapts the output of the motor 42 to rotate the primary motor shaft 100 about a motor shaft axis to rotation about the drive shaft axis of the drive shaft 44, wherein the motor shaft axis is perpendicular to the drive shaft axis. To transmit rotational motion between the primary motor shaft 12 and the drive shaft 44, which are perpendicular to one another, various gear assemblies may be used. For example, bevel gears can be arranged to transfer power between intersecting shafts at 90 degrees, as can worm and wheel gears for non-intersecting, perpendicular shafts. In another alternative, hypoid gears can be arranged to allow power transfer for offset of drive shaft 44 and motor shaft.

Referring briefly to FIGS. 6 and 11, the gear assembly 43 within the example embodiment comprises a series of interlocking gears designed to convert and reduce the rotational speed from the motor shaft 100 to the drive shaft 44. The gear assembly initiates with a worm gear 102 supported by the motor shaft 100 in a rotationally fixed manner and which engages a first gear 104. The first gear 104, typically a helical or spur gear, meshes directly with the worm gear 102 to initiate the reduction of rotational speed and increase torque output. Following this, a second gear 105, also a helical or spur gear, meshes with the first gear 104 to further decrease the speed while stabilizing the torque transfer process. Additionally, a further gear 107 (FIG. 11) is rotationally fixed to the drive shaft 44, completing the speed reduction cascade. This further gear, potentially a bevel or spur gear ensures the final adjustment in rotational speed and torque necessary for optimal drive shaft performance.

Turning again to FIGS. 3 and 5, The rectangular gearbox housing 41 has a flat upper surface from which the drive shaft 44 extends (through an opening in the upper surface) upwardly and perpendicularly relative to the flat upper surface. The drive shaft 44 includes a keyed surface 45 at its upper end, designed to engage with a correspondingly keyed surface of the hub sleeve 110 of the turntable 28.

The drive shaft 44 passes through a central opening in the bearing cap 38, a central opening of the bearing 36, through a central opening in the circular platform 51 and through the central opening in the alignment collar 13. The rotation of the drive shaft 44 is stabilized and supported by the bearing 36, ensuring smooth operation.

The design of the motor assembly 40 in the rotational craft tool 10 supports compactness particularly through the perpendicular gear transmission within a confined gearbox housing 41 and maximizes the use of space within housing 16 of the rotary craft tool 10, while ensuring robust power transmission capabilities.

The battery 34 is a rechargeable battery. The battery 34 may be a rechargeable lithium-ion battery pack enclosed within the housing 16. The battery 34 may be of other kinds including a lithium iron phosphate battery, a nickel-metal hydride or other kinds. The battery 34 provides a portable power source, allowing cordless operation. The battery 34 is electrically connected to the motor 42 for providing power to operate the motor 42. The battery 34 is electrically connected to the USB Printed Circuit Board (PCB) 48 for charging.

A foam liner 32 is provided above the battery 34 and is disposed between an inside surface of the housing main body 50 to dampen vibration and noise. Rubber or other sound and vibration absorbing materials, such as polyurethane foam, neoprene, or viscoelastic foam, could be used. Further vibration and noise dampening features of the rotary craft tool 10 will be described in greater detail below.

The control PCB 46 and the USB PCB 48 are printed circuit boards equipped with electronic components for managing power and data connections. The control PCB 46 receives signals from the potentiometer 30 (or rotary encoder or other sensor) based on user adjustment of the dial 14 and a sensor to measure an actual rotational speed of the motor shaft 100 to manage the function of the motor 42, while the USB PCB 48 facilitates charging of the battery 34 using power supplied via the USB port 20 and/or direct power supply from the USB port 20 to the motor 42. The control PCB 46 includes the control system 80 that is described further below with reference to FIG. 10. The control PCB 46 and the USB PCB 48 are electronically linked for coordinated operation between power management and user controls. Additionally, the port 20 could be used to update the software that controls electronics of the craft tool, enhancing functionality or performance through firmware upgrades. Moreover, leveraging the latest USB-C PD (Power Delivery) protocol, the internal battery can also be used to power other devices when connected, providing added utility and flexibility. In some embodiments, the control PCB 46 and the USB PCB 48 may be integrated into a single PCB.

The rotational craft tool 10 includes a cradle 49 that is secured with the union between the housing base 52 and the housing main body 50. The cradle 49 forms a support base to receive the motor assembly 40. The cradle 49 defines a receptacle that receives the gear box housing 41 between lateral walls of the receptacle. The cradle 49 defines first and second pillars on opposed sides of the cradle 49 for supporting the battery 34 above the motor 42. In the example embodiment, a longitudinal axis of the battery 34 is perpendicular to a longitudinal axis of the motor 42, wherein the motor 42 is disposed between the opposed pillars 47 and extends along a space between the opposed pillars 47, which is along a longitudinal axis of the housing 16 extending between opposed ends.

The rotational craft tool 10 includes vibration and noise dampening features. These features significantly improve the precision and quality of crafting, as they reduce tool jitter and noise, allowing for smoother operation and finer detail work. Additionally, by minimizing vibration, these dampening features ensure that the tool's components operate under less mechanical stress, which not only prolongs their lifespan but also maintains the consistency and accuracy of performance, critical for high-quality crafting results.

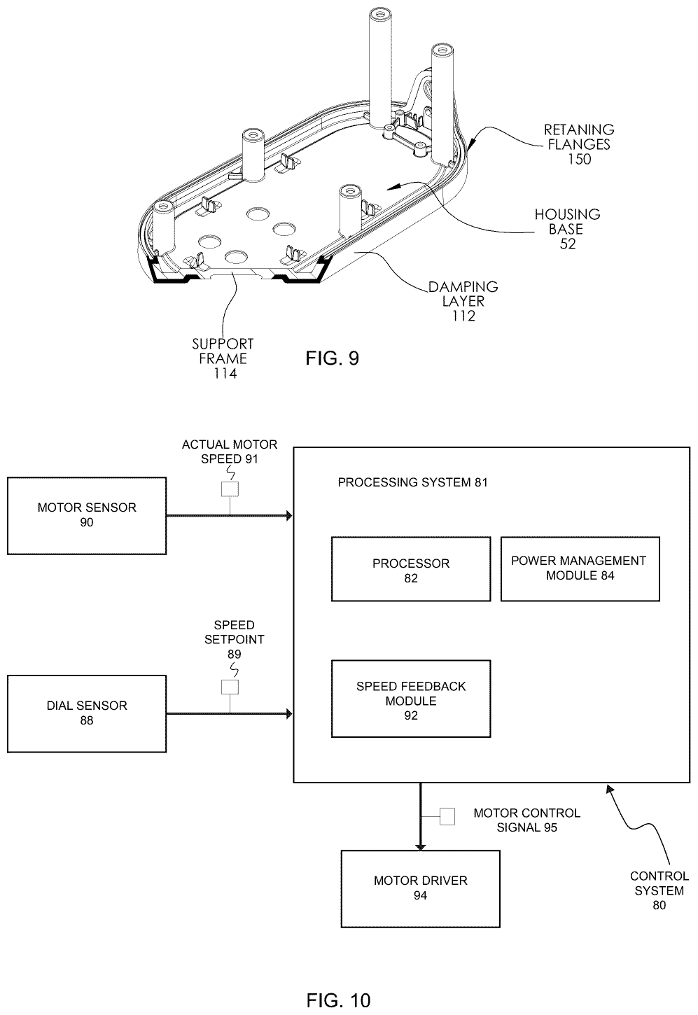

In particular, and referring to FIG. 9, an isolated view of the housing base 52 is illustrated. The housing base 52 includes a damping layer 112 and a support frame 114. The housing base 52 is generally obround shaped, but other shapes are envisaged, and the damping layer 112 extends around a periphery of the housing base 52 and thus is, in isolation, provides a generally obround shaped damping ring. The support frame 114 is constructed from a thermoplastic polymer which offers robust mechanical properties suitable for structural applications. Examples of suitable materials include polycarbonate (PC), acrylonitrile butadiene styrene (ABS), and polyamide (PA), among others. Rubber is used as the damping layer 112 in one embodiment due to its vibration absorption properties, but alternative materials are also considered to achieve similar or enhanced vibration reduction. Options such as silicone, polyurethane, thermoplastic elastomers, and specially formulated damping composites are contemplated for their ability to provide effective noise and vibration dampening across different operating conditions and durability requirements. The damping layer 112 provides a lowermost surface of the rotational craft tool 10 so that the damping layer 112 is the contact surface with a horizontal surface on which the rotational craft tool 10 is placed such that the support frame 114 does not contact the horizontal surface. The support frame 114 provides a relatively hard support foundation for securing the cradle 49 thereto.

The damping layer of the housing base 52 includes vertical retaining flanges 150 extending around a periphery of the housing base 52, which are strategically spaced to snugly receive and secure a peripheral lower wall of the housing main body 50. The retaining flanges 150 ensure proper alignment and stabilization of the housing main body 50 within the damping layer.

The damping layer 112 acts as the primary interface between the rotational craft tool 10 and any horizontal surface it is placed upon, thereby isolating the support frame 114 from direct contact with the surface. This configuration minimizes the transmission of vibrational energy from the tool to the surface, enhancing the operational stability and reducing noise during use. Additionally, the inclusion of vertical retaining flanges 150 on the damping layer 112 around the periphery of the housing base 52 ensures that the peripheral lower wall of the housing main body 50 is securely and accurately positioned, which not only stabilizes the entire assembly but also contributes to the effective damping of vibrations.

The damping layer 112 and the support frame 114 of the housing base 52 can be manufactured using a two-shot moulding process. This technique, also known as dual-material injection moulding, involves injecting two different types of plastics into the same mold in sequential steps during a single moulding cycle. For the damping layer 112, materials like silicone or thermoplastic elastomers (TPE) are injected first. Following this, a harder, more rigid plastic such as polycarbonate (PC) or acrylonitrile butadiene styrene (ABS) or a mixture thereof are injected to form the support frame 114.

Another noise and vibration damping feature employed by the rotational craft tool 10 includes damping elements 152, such as ThermoPlastic Rubber (TPR) washers. Silicone washers and neoprene pads offer viable alternatives to TPR. The damping elements 152 are positioned around threaded fasteners, in one embodiment, to secure the housing base 52 to the cradle 54, the gear box housing 41 to the cradle and the cradle 54 to the housing main body 56. The damping elements 152 serve the function of absorbing and reducing vibrations transmitted through the rotational craft tool 10 during operation.

Non-washer damping elements could be employed at attachment points (fastener locations) between the cradle 49 and the housing base 52, the cradle 49 and the housing main body 50 and between the gearbox housing 41 and the cradle 49 such as pads or strips made from vibration-absorbing materials. These pads can be similarly placed between the cradle 54 and the housing base 52 and between the cradle 54 and the housing main body 56 to provide cushioning and vibration damping. Rubber or silicone grommets can also serve as effective damping elements.

Further, one or more motor damping elements 180 are positioned between the cradle 49 and the motor 42. In one embodiment, the one or more motor damping elements 180 are provided in the form of tubes that extend along opposed sides of the motor 42, parallel to a longitudinal axis of the motor 42. Alternative embodiments may include pads and/or strips or damping grommets or isolators placed at mounting points between the motor 42 and the cradle 49. The one or more damping elements 180 may be made from rubber, viscoelastic polymers, silicone, or specially formulated damping composites or elastomeric foams.

Further, the foam liner 32 described above offers damping and cushioning effects.

The damping layer 112 might also serve as a seal, offering waterproof protection of the rotational craft tool 10, between the housing base 52 and the housing main body 50. Alternatively, if it does not function as a seal, a separate gasket may be utilized to maintain waterproof integrity. The damping layer 112 or other gasket serve as protection to the power button 22 and USB port 20.

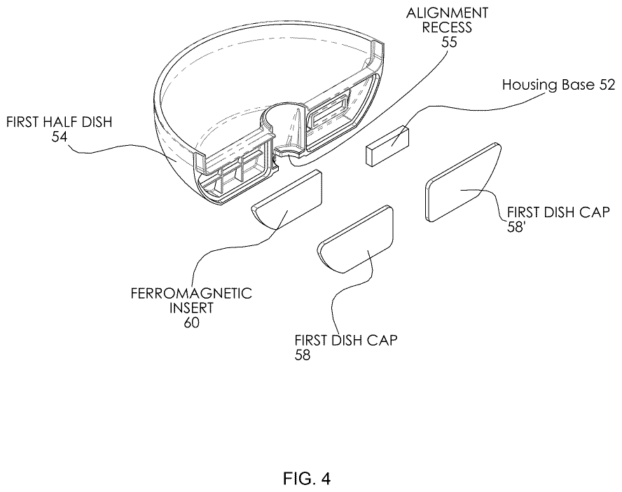

Referring to FIGS. 4 and 5, the dish assembly 18 is shown in further detail in accordance with embodiments of the present disclosure. The dish assembly 18 provides splash protection and includes a first half dish 54 and a second half dish 66. The first half dish 54 and the second half dish 66 are able to be removed from the rotational craft tool 10 by pulling the halves apart for ease of cleaning. The first half dish 54 and the second half dish 66 are secured around the turntable assembly 12 and include alignment recesses 55 that receive alignment tabs 53 of the alignment collar 13 to provide mechanical securement of the dish assembly. The first half dish 54 and the second half dish 66 are connectable to each other by magnetic attraction. It has been found that requiring oppositely polarity magnets that are facing each other in the first half dish 54 and the second half dish 66 complicates manufacturing and can lead to defective products. Each of the first half dish 54 and the second half dish 66 include magnets 56 and ferromagnetic inserts 60 that are disposed on diametrically opposite sides of the first and second half dishes 54, 66. The magnet 56 of the first half dish 54 faces the ferromagnetic insert 60 of the second half dish 66 and the magnet 56 of the second half dish 66 faces the ferromagnetic insert 60 of the first half dish. That is, the magnet 56 and the ferromagnetic insert 60 of the first half dish 54 is located in a diametrically opposite manner to the magnet 56 and the ferromagnetic insert 60 of the second half dish 66. Since the magnetic field of the magnet 56 of one half dish influences the magnetic domains within the ferromagnetic insert 60 of the other half dish, the ferromagnetic material moves toward the source of the magnetic field, thereby inducing attraction. This attraction occurs regardless of the polarity of the magnet 56 because the domains in the ferromagnetic material will orient to complement the external magnetic field's direction. As such, manufacturing is simplified as cooperative alignment between facing pairs of magnets is not required. In some embodiments, the ferromagnetic inserts 60 are ferromagnetic steel inserts.

The ferromagnetic inserts 60 of one half dish has a surface facing a surface of the magnet 56 of the other half surface that is larger to ensure effective coupling of the first and second half dishes 54, 66.

Dish caps 58 are provided to secure the ferromagnetic inserts 60 and the magnets 56 of each of the first and second dish halves 54, 66. The dish caps 58 are secured to the first and second dish halves 54, 66, optionally by way of ultrasonic welding but other methods are envisaged such as snap fitting, adhesive, overmoulding, etc.

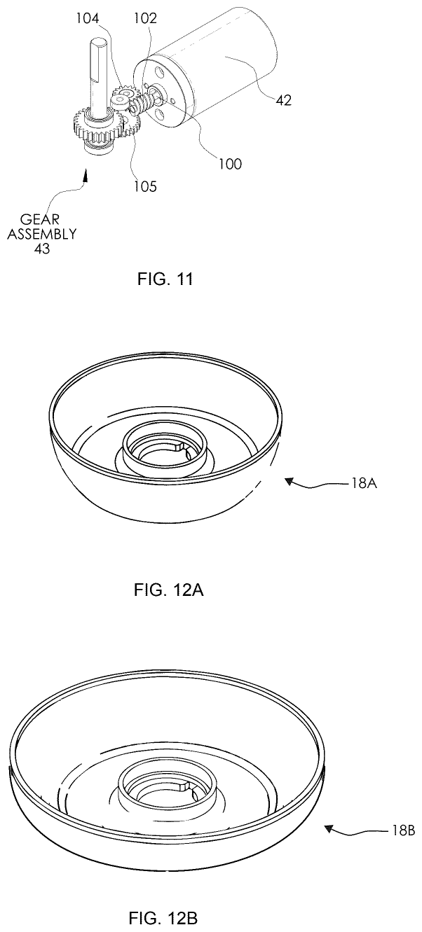

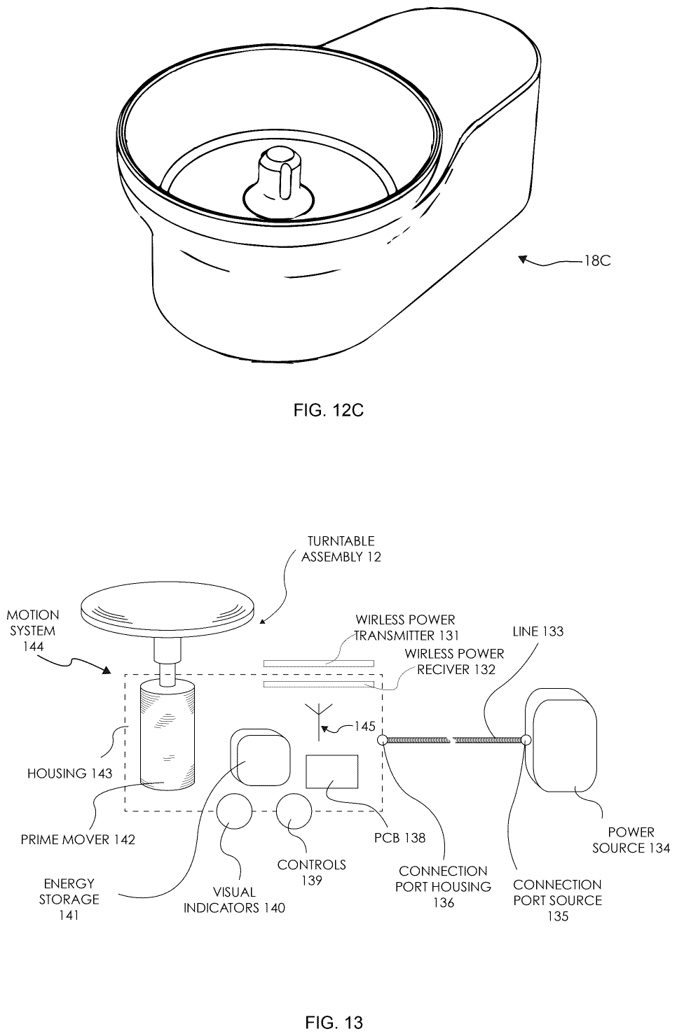

FIGS. 12A to 12C illustrate alternative embodiments of the dish assembly 18 in accordance with some embodiments. In FIG. 12A, the dish assembly 18A is provided as a single piece that is connectable to the alignment collar 13 or other attachment member associated with the drive shaft 44 by bayonet coupling or some other coupling allowing removable attachment. In FIG. 12B, the dish assembly 18B is a one or two-piece alternative (as described above) that has a wider diameter to increase width of the water capture channel defined by the dish assembly. That is, FIG. 12B illustrates that alternative dish assembly sizes may be utilized. In FIG. 12C another alternative is illustrated in which the dish assembly 18C is integrated with the housing 16 and a wider drive shaft portion is shown that covers and has a large diameter than an opening through the dish assembly 18C through which the drive shaft extends.

The rotational craft tool 10 of the present disclosure has been designed to ensure compactness for portability whilst also accommodating battery operation and high performance. Referring to FIG. 1, the housing 16 has a height of opposed sidewalls 184 that varies between opposed end walls 186 so as to provide a top wall 182 at one end of the housing 16 that is raised relative to the circular platform 51. The top wall 182 may be approximately vertically aligned with the turntable 28. The raised height part of the housing 16 provides space accommodating the battery 34, which is vertically stacked over the motor 42. Further, a longitudinal axis of the control PCB 46 extends vertically in that the board itself is supported on a board thickness edge and extends vertically so as to span an end of the motor 42 and an end of the battery 34 at the raised height part of the housing 16. The control PCB 46 is positioned between the power button 20 and the motor 42 and the battery 34.

FIG. 10 provides a schematic block diagram of a control system 80 including a motor sensor 90 providing actual motor speed 91 to a processing system 81, a dial sensor 88 providing a setpoint 89 to the motor system 91, the processing system 81 and a motor driver 94 receiving a motor control signal from the processing system 81. The processing system 81 includes a processor 82, a speed feedback module 92 and a power management module 84.

The motor sensor 90 is tasked with monitoring the actual motor speed and generating a feedback signal embodying actual motor speed 91, which reflects the current operational speed of the motor. Motor sensor 90 could be a tachometer, which measures rotational speed using optical or contact methods, or a Hall Effect sensor, detecting magnetic fields to determine motor speed and position. Alternatively, an encoder, either optical or magnetic, capacitive, inductive, fibre optic provides precise feedback on both speed and position by reading changes in light, capacitance, inductance, or magnetic fields as the motor rotates.

The actual motor speed signal 91 may be a square wave frequency that varies proportionally with the rotational speed of the motor. The frequency of the square wave may range from about 16 Hz, corresponding to a motor speed of 15 rpm, to 170 Hz, which correlates to 160 rpm. The square wave signal is generated by the motor sensor 90 and provides real-time feedback on the actual speed of the motor to the processing system 81. As alternatives, the motor speed signal could also be conveyed through an analog voltage that varies linearly with the speed or a pulse-width modulated (PWM) signal where the duty cycle adjusts according to the speed of the motor. Since the gear assembly reduces the speed from the motor to the turntable, the motor speed may be appropriately adjusted by the processing system 81.

The dial sensor 88 detects user inputs and provides a speed setpoint 89, derived from the rotational position of the potentiometer 30 or rotary encoder. The setpoint 89 represents the user's desired speed as set by the user through the dial 14. The speed setpoint 89 determined by the rotational position of the potentiometer 30 may take the form of an analog voltage that varies according to a predetermined response curve—linear, logarithmic, or otherwise—with the rotation of the dial 14, providing a direct, contextually, proportional representation of the user's desired speed. Where a rotary encoder is used as a dial sensor, the rotary encoder converts the dial's rotational position into digital signals, which are then used to determine the user's desired speed.

Within the processing system 81, the processor 82 acts as the central unit coordinating the control system's response to input data. The processor 82 is configured to execute stored instructions in the form of software modules. The processor 82 is operatively coupled to a non-transitory computer-readable medium that stores the software modules, which are executable by the processor 82. These software modules include, but are not limited to, the speed feedback module 92 and the power management module 84.

The processing system 81 receives the actual speed data 91 from the motor sensor 90 and the desired speed setpoint 89 from the dial sensor 88. The speed feedback module 92 within the processing system 81 compares the actual motor speed 91 and the speed setpoint 89 values to determine whether the actual speed matches the user's demand. Based on this comparison, the processor 82 formulates a motor control signal 95, which is forwarded to the motor driver 94.

The speed feedback module 92 may operate by calculating an error value between the actual motor speed 91 and the desired speed setpoint 89. To effectively minimize this error and achieve speed control, the speed feedback module 92 may employ a Proportional-Integral-Derivative (PID) control algorithm. The PID algorithm adjusts the motor speed by continuously calculating the error value and applying a corrective action that is proportional to the sum of present errors, accumulated past errors, and the predicted future errors, based on the rate of change.

In one embodiment, the speed feedback module 92 receives a square wave

frequency signal from the motor sensor 90, which directly corresponds to the current motor speed, the speed feedback module 92 computes the actual motor speed by analyzing the frequency of the square wave. The speed feedback module 92 then compares this actual speed value with the desired speed setpoint 89, received from the dial sensor 88. If a discrepancy between the actual and desired speeds is detected—whether the actual speed is higher or lower than set—the speed feedback module 92 dynamically adjusts the output signals to the motor driver 94, instructing it to either increase or decrease the motor speed accordingly.

The motor driver 94, upon receiving the motor control signal 95 from the processing system 81, adjusts the operational parameters of the motor 42 to synchronize the actual motor speed with the desired setpoint as determined by the dial sensor 88. The motor control signal 95 encompasses both amplitude and frequency adjustments that dictate the power output to the motor 42. In practical terms, the motor driver 94 may vary the voltage and current supplied to the motor 42, or modulate these parameters through techniques such as pulse-width modulation (PWM) to control the speed and torque of the motor 42. Such adjustments compensate for varying load conditions that the turntable assembly 12 may encounter during different crafting operations. For instance, a heavier clay piece on the turntable may require more torque to maintain the same rotational speed, prompting the motor driver 94 to compensate by increasing the power supply. Conversely, with lighter loads, the driver can reduce the power to prevent the motor 42 from exceeding the set speed. These dynamic adjustments ensure that the rotational craft tool 10 operates consistently and efficiently, providing a stable and reliable crafting experience regardless of the load variations.

The power management module 84 controls distributing and managing power within the rotational craft tool 10 including sourcing power from the USB port 20, controlling charging of the battery 34, and supplying power to the motor 42.

The power management module 84 monitors the incoming power from the USB port 20 and determines if the USB port 20 is providing sufficient power, the power management module 84 decides whether to directly power the motor 42 or prioritize charging the battery 34.

When the USB port 20 is providing power and the priority is set to charge the battery 34, the power management module 84 regulates the charging process to ensure the battery 34 is charged. This may involve monitoring the voltage and current levels of the battery 34, implementing charging algorithms such as constant current and constant voltage charging, and preventing overcharging or overheating of the battery cells.

In scenarios where the USB port 20 cannot supply enough power to meet operational demands, the power management module 84 dynamically allocates power from the battery 34.

The power management module 84 may incorporate various protection mechanisms to safeguard the rotational craft tool 10n and its components from power-related faults. This includes overcurrent protection, overvoltage protection, undervoltage protection, and short-circuit protection. In the event of a fault, the module takes appropriate actions such as shutting down the motor 42 or isolating the battery 34 to prevent damage to the tool or the power source.

FIG. 13 provides a schematic illustration of a rotational craft tool in accordance with embodiments of the present invention. Many of the features of the present embodiment are similar to those described with reference to the foregoing figures and thus the following description is applicable, in large part, to that described above. Any differences will be made clear in the following description of FIG. 13.

The housing 143 encases all operational components of the rotational craft tool, designed to accommodate various configurations while protecting and integrating the internal components effectively. The turntable assembly 12 is a central component of the tool that provides the main rotational functionality. The turntable assembly 12 is driven by the prime mover (e.g. the motor as described above) through a mechanical linkage that translates motor power into rotational motion of the turntable assembly 12. The prime mover 142 represents the main driving force of the tool, depicted as capable of operating with various power sources. It can be an AC/DC motor configured to provide direct drive or to use a gear reduction system for adjusting the output speed and torque.

Energy storage 141 is capable of using multiple storage technologies, this component provides power sustainability or supplementation to the prime mover 142. It may be implemented with batteries or capacitors. A wireless power transmitter 131 may be included, which is external to the tool and provides power to an internal wireless power receiver 131. These power transmitting and receiving components allows the tool to receive power through wireless energy transfer technologies, such as Electromagnetic Induction and Magnetic Resonance, allowing for a cordless operation in terms of powering the prime mover 142 and charging the energy storage 141. Such wireless power transmission may be included in all embodiments described herein.

Controls 139 may be included within the housing 143 as described in the previous embodiments or may include remote operation (e.g. operation through an external processing device), which is an option applicable to all embodiments described herein. This flexibility highlights the tool's adaptability to different user preferences and operational environments.

A PCB 138 manages communications, power regulations, and functional operations within the tool. This component is crucial for integrating the controls, power management, and wireless communication functionalities.

A connection port housing 136 provides the interface for power and data transfer with external power and data sources through line 133 and connection port source 135 of an external power source 134. In each embodiment of the present disclosure, power and data communication with external devices can be wireless or cabled.

Visual indicators 140 provide a user interface and can include various forms of displays or lights, providing feedback and settings adjustment capabilities directly on the tool.

An antenna 145 provide for wireless communication to the PCB 138 for managing remote control actions, data transmission, and receiving wireless updates.

The invention has been described by reference to certain embodiments discussed above. It will be recognized that these embodiments are susceptible to various modifications and alternative forms well known to those of skill in the art.

For example, in an alternative embodiment of the rotational craft tool, the device incorporates a power management module that utilizes advanced power delivery protocols to optimize energy efficiency and operational voltage and current levels. This module is designed to communicate with a variety of power sources, ensuring that the most efficient and suitable power settings are applied based on available resources. For instance, when connected to a power source supporting modern power delivery standards, the module can negotiate necessary voltage and current settings, such as 15V or 20V, which are critical for optimal operation of the motor and other components. This ability to adaptively manage power not only enhances the tool's performance and flexibility but also contributes to energy conservation and extended battery life. The interface of this module is designed to be forward-compatible, accommodating not only current USB-C standards but also other emerging or existing power delivery formats through the use of adaptable connectors or adapters. This ensures that the tool remains compatible with future technological advancements in power delivery, making it a versatile choice for various crafting environments. The power management module is specifically engineered to interface seamlessly with USB-C ports, utilizing a dedicated PCB (or included in the above described PCB) that supports the USB-C protocol for power delivery. This configuration allows the PCB to directly interact with the USB-C port, enabling the tool to efficiently manage power input and request specific voltages, such as 15V or 20V, necessary for optimal motor performance and extended device operation under diverse operating conditions

Further modifications in addition to those described above may be made to the structures and techniques described herein without departing from the spirit and scope of the invention. Accordingly, although specific embodiments have been described, these are examples only and are not limiting upon the scope of the invention.

What is claimed is:

1-5. (canceled)

6. A rotational craft tool, comprising:
a housing;
a motor included in the housing;
a turntable assembly;
the motor operatively connected to the turntable assembly for rotating the turntable assembly; and
a control system configured to adjust a speed or power of the motor using a feedback loop in which an error between a setpoint rotational speed of the motor and a sensed rotational speed of the motor is minimized.

7. The rotational craft tool of claim 6, wherein the setpoint rotational speed of the motor is set by a dial of the rotational craft tool by a user.

8. The rotational craft tool of claim 6, wherein the dial is associated with a potentiometer or rotary encoder that provides an input voltage depending on the dial position, which is converted to the setpoint rotational speed.

9. The rotational craft tool of claim 6, comprising a sensor for providing the sensed rotational speed of the motor.

10. The rotational craft tool of claim 1, comprising:
a dial operable by a user, wherein a rotational direction of the dial sets a rotational direction of the turntable assembly by the motor and an extent of rotation sets a speed of rotation of the turntable assembly by the motor in the rotational direction.

11. The rotational craft tool of claim 10, wherein a clockwise rotation of the dial relative to a null position of the dial sets a clockwise rotational direction of the turntable assembly by the motor and an anticlockwise rotation of the dial relative to the null position of the dial sets an anticlockwise rotation of the turntable assembly by the motor or wherein a clockwise rotation of the dial relative to a null position of the dial sets an anti-rotational direction of the turntable assembly by the motor and an anticlockwise rotation of the dial relative to the null position of the dial sets a clockwise rotation of the turntable assembly by the motor.

12. The rotational craft tool of claim 10, comprising a sensor for measuring the rotational direction and extent of rotation of the dial and providing an output signal to a control system for controlling the rotational direction and speed of the motor.

13. The rotational craft tool of claim 12, wherein the sensor comprises a potentiometer or rotary encoder.

14-25. (canceled)

26. A rotational craft tool, comprising:
a turntable assembly;
a motor for rotating the turntable assembly; and
a dish assembly surrounding the turntable assembly for splash protection;
wherein the dish assembly comprises a first dish half and a second dish half that are detachable from each other for removal from the rotational craft tool; and
wherein the first dish half and the second dish half are magnetically securable to one another, the first dish half and the second dish half each including:
a magnet; and
a ferromagnetic insert;
the magnet of the first half dish arranged to face the ferromagnetic insert of the second half dish and the magnet of the second half dish arranged to face the ferromagnetic insert of the first half dish when the first half dish and the second half dish are secured to one another.

27. The rotational craft tool of claim 26, wherein the turntable assembly is connected to a drive shaft rotatable by the motor, wherein the rotational craft tool comprises an alignment collar disposed about the drive shaft and wherein the first dish half and the second dish half and the alignment collar have cooperating alignment features.

28. The rotational craft tool of claim 26, comprising:
a housing;
a power storage;
a motor assembly comprising a motor and a gear box housing, the gear box housing comprising a gear assembly;
wherein the turntable assembly is rotatable by the motor via the gear assembly and is powered by the power storage; and
wherein the motor is elongate and includes a longitudinal motor axis and the power storage is elongate and includes a longitudinal power storage axis, the power storage arranged within the housing above the motor when the rotational craft tool is placed on a horizontal surface and such that the motor axis and the power storage axis are perpendicular to one another.

29. The rotational craft tool of claim 28, wherein the housing has a generally obround shape in plan view having a housing longitudinal axis extending between opposed ends, wherein the motor longitudinal axis is aligned with the housing longitudinal axis.

30. The rotational craft tool of claim 28, comprising a rotatable drive shaft connected to the gear assembly and extending through an opening in a platform of the housing to connect to the turntable assembly, the turntable assembly supported above the platform of the housing with respect to a vertical extension of the rotatable drive shaft when the rotational craft tool is placed on a horizontal surface.

31. The rotational craft tool of claim 30, wherein the housing has relatively higher side walls at one end as compared to side walls along the platform to provide additional internal volume for accommodating the power storage.

32. The rotational craft tool of claim 28, wherein the housing comprises first and second pillars for supporting the power storage above the motor, the motor received in a space between the pillars.

33. The rotational craft tool of claim 28, comprising a Printed Circuit Board (PCB) for regulating rotational speed of the motor, wherein a longitudinal axis of the PCB extends vertically.

34. A rotational craft tool, comprising:
a housing;
a motor included in the housing;
a turntable assembly;
the motor operatively connected to the turntable assembly for rotating the turntable assembly; and at least one of:
a data transfer method to control software or hardware;
a power storage included in the housing to provide power to the motor and a wireless connectivity to wirelessly charge the power storage or power the motor directly or both; and
a power storage included in the housing to provide power to the motor, a printed circuit board (PCB) configured to control operation of the motor, a power management module compatible with a power delivery standard capable of dynamically controlling and adjusting voltage and current supplied to the PCB from a compatible power source via a power input interface for receiving an external connector.

35. The rotational craft tool of claim 34, comprising:
a Universal Serial Bus (USB) port for supplying power to charge the power storage and/or to power the motor and/or power other devices; and/or
a Universal Serial Bus (USB) port for data transfer to update firmware and/or control the rotational craft tool and/or provide logs and/or advanced settings.

36. (canceled)

37. The rotational craft tool of claim 34, comprising wireless for data transfer to update firmware and/or control the rotational craft tool and/or provide logs and/or advanced settings.

38-39. (canceled)

40. The rotational craft tool of claim 39, wherein the interface is configured for receiving a USB connector and other power delivery connectors, and/or wherein the interface is configured for receiving a USB-C connector and the power delivery standard is USB-C power delivery.

41. (canceled)
